(19) United States
(12) Patent Application Publication
(10) Pub. No.: US 2008/0128006 A1
(43) Pub. Date: Jun. 5, 2008

(54) Method for controlling a cleaner and cleaner for performing the method

(75) Inventors: Harald Mayer, Bubsheim (DE); Martin Wegner, Fellbach (DE); Gottfried Benzler, Kirchberg (DE); Yunus Demirtas, Kornwestheim (DE); Felix Treitz, Berglen (DE); Juergen Binder, Leutenbach (DE); Matthias Steinmann, Berglen (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 11/998,467

(22) Filed: Nov. 29, 2007

Related U.S. Application Data
(63) Continuation of application No. PCT/EP2006/003664, filed on Apr. 21, 2006.

(30) Foreign Application Priority Data
Jun. 13, 2005 (DE) 10 2005 028 116

(51) Int. Cl. B08B 3/02; G05D 16/00

(52) U.S. Cl. 134/56 R; 700/301

(57) ABSTRACT

The invention relates to a method for controlling the operating mode of a cleaner, in particular, a high-pressure cleaner, wherein a pump delivers cleaning fluid via a pressure line to a closable spray nozzle, a signal transducer which provides control signals as a function of the pressure in the pressure line being coupled with the pressure line. To further develop the method so that the cleaner can be reliably controlled in a constructionally simple manner from the spray nozzle, it is proposed, in accordance with the invention, that a first control signal be provided by the signal transducer by closing the spray nozzle, and a second control signal be provided by the signal transducer by subsequently opening the spray nozzle again, and that the operating mode of the cleaner be controlled as a function of the duration of the time interval between the two control signals. A cleaner, in particular, a high-pressure cleaner, for performing the method is also proposed.

This application is a continuation of international application number PCT/EP2006/003664 filed on Apr. 21, 2006.

The present disclosure relates to the subject matter disclosed in international application number PCT/EP2006/003664 of Apr. 21, 2006 and German application number 10 2005 028 116.8 of Jun. 13, 2005, which are incorporated herein by reference in their entirety and for all purposes.

### BACKGROUND OF THE INVENTION

The invention relates to a method for controlling the operating mode of a cleaner, in particular, a high-pressure cleaner, wherein a pump delivers cleaning fluid via a pressure line to a closable spray nozzle, a signal transducer which provides control signals as a function of the pressure in the pressure line being coupled with the pressure line, wherein a first control signal is provided by the signal transducer by closing the spray nozzle, and a second control signal is provided by the signal transducer by subsequently opening the spray nozzle again, and wherein the operating mode of the cleaner is controlled as a function of the duration of the time interval between the two control signals.

The invention also relates to a cleaner, in particular, a high-pressure cleaner, for performing the method, having a pump for delivering cleaning fluid via a pressure line to a closable spray nozzle, wherein a signal transducer is coupled with the pressure line for providing control signals as a function of the pressure in the pressure line, wherein a first control signal is emittable by the signal transducer by closing the spray nozzle, and a second control signal is emittable by the signal transducer by subsequently opening the spray nozzle again, and wherein the operating mode of the cleaner is controllable as a function of the duration of the time interval between the first control signal and the second control signal.

A high-pressure cleaner is known from EP 0 120 331 B1, wherein the pressure in the pressure line is increased by closing the spray nozzle until a pressure switch placed in the pressure line responds and switches off the electric motor. If the spray nozzle is subsequently opened again, a very strong drop in the pressure in the pressure line then occurs within a short time. This has the consequence that the pressure switch responds anew and switches on the electric motor. To control the dosing of a cleaning chemical from the spray nozzle, the spray nozzle comprises in addition to a first flow path a second flow path connected in parallel, which can be activated by the user at the spray nozzle, so that the pressurized cleaning fluid can subsequently be discharged via both flow paths. The activating of the second flow path results in a change in the pressure rise time in the pressure line. This pressure rise time can be evaluated by a timer of the high-pressure cleaner to generate a control signal with which the dosing of the chemical can be switched on.

A high-pressure cleaner is known from DE 32 16 577 A1, wherein there is placed in the pressure line an electrical transducer, which generates an electric signal proportional to the pressure, and with which there is associated an electrical control device, so that the delivery of the cleaning fluid and/or the delivery of a cleaning chemical and also the operation of a heat exchanger heated by a burner can be controlled as a function of the electric signal generated by the transducer. The spray nozzle is adjustable by degrees, and depending on the degree of opening of the spray nozzle, a certain pressure arises in the pressure line, which is detected by the transducer. The delivery of the cleaning fluid and the cleaning chemical and also the operation of the burner can thus be controlled as a function of the pressure arising in the pressure line.

A high-pressure cleaner is known from DE 42 11 788 A1, wherein the current taken up by the electric motor can be measured and the rotational speed of the electric motor adjusted to a low value when the motor current rises above a maximum value lying above the value during normal operation. If the motor current falls below a minimum value lying below the value during operation at low rotational speed, then the rotational speed can be adjusted again to a value corresponding to normal operation. The changes in the motor current are caused by changes in the pressure prevailing in the pressure line. Therefore, by selectively opening and closing the spray nozzle, the pressure in the pressure line and hence also the motor current can be changed in order to control the rotational speed of the electric motor. However, the value of the motor current is not exclusively dependent upon the pressure prevailing in the pressure line. Rather, the value of the motor current is also subject to other influencing variables, for example, the value of the supply voltage to which the electric motor is connected. The electric motor is usually connected to the mains power supply. This is subject to not inconsiderable fluctuations, which can result in a change in the motor current.

A control circuit for a high-pressure cleaner is known from DE 34 02 450 A1, wherein a pressure monitoring switch is coupled with the pressure line of the high-pressure cleaner. The pressure monitoring switch is connected to a timer. A first control signal can be provided by closing a spray nozzle, and a second control signal can be provided by subsequently opening the spray nozzle again. The timer is put into operation by the second control signal, and following lapse of a prescribed period of time without the occurrence of any events the high-pressure pump is switched off. If, however, a control signal is generated again during the period of time, then operation of the high-pressure pump is continued.

The object of the present invention is to further develop the method mentioned at the outset and a corresponding cleaner so that the operating mode of the cleaner can be reliably changed in a constructionally simple manner from the spray nozzle.

### SUMMARY OF THE INVENTION

This object can be accomplished, in accordance with the invention, in a method of the generic kind in that the operating mode, in particular, the operating pressure, of the cleaner is changed if the time interval between the first control signal and the second control signal is shorter than a first prescribed period of time.

The invention incorporates the concept that a constructionally simple remote control of the cleaner can be achieved by the user briefly closing the spray nozzle while the cleaner is in operation and then opening it again, the opening and closing of the spray nozzle being detected by the signal transducer, which respectively provides a control signal. The operating mode of the cleaner can be controlled as a function of the duration of the time interval between the two control signals. Here, the operating mode of the cleaner is to be understood, in particular, as its operating pressure, i.e., the pressure at which the cleaning fluid is conveyed by the pump to the spray nozzle during normal operation. However, the operating mode of the cleaner also relates to the selective dosing of a cleaning fluid or the activation of a heat exchanger heated by a burner. In the method according to the invention, the operating mode of the cleaner can be controlled as a function of the duration of the time interval between a first control signal corresponding to the closing of the spray nozzle and a second control signal corresponding to the subsequent opening of the spray nozzle again.

In accordance with the invention, it is provided that the operating mode of the cleaner, in particular, the operating pressure of the cleaner, is changed if the time interval between the first control signal and the second control signal of the signal transducer, in particular, the time interval during which the electric motor is switched off, is shorter than a first prescribed period of time. The operating mode can be changed in a simple manner by closing the spray nozzle for a time interval that is shorter than a first prescribed period of time, which, for example, can be 0.5 to 2 seconds. If the user closes the spray nozzle for a time that is shorter than the first prescribed period of time, then the operating mode of the cleaner is automatically changed. The electric motor can be switched off briefly and hence the motor current interrupted by the brief closing of the spray nozzle and the subsequent opening of the spray nozzle again. If the duration of the interruption of the motor current falls short of the first prescribed period of time, then the operating mode, in particular, the operating pressure, of the cleaner is changed.

It is advantageous for the pump of the cleaner to be driven by an electric motor, which is switched off by the first control signal of the signal transducer and is switched on by the second control signal of the signal transducer. The operating mode of the cleaner can, therefore, be controlled as a function of the duration between the switching-off and the switching-on again of the electric motor. By switching off the electric motor, its motor current is briefly interrupted, and the duration of the respective interruption of the motor current can be used to control the operating mode of the cleaner. By closing the spray nozzle and by subsequently opening it again, a first control signal and a second control signal are generated one after the other, which have the consequence that the electric motor is switched off and subsequently switched on again. By briefly closing the spray nozzle, it is, therefore, possible to bring about in a constructionally simple manner an interruption of the motor current which is limited with respect to time and can be detected, for example, by a current sensor. Therefore, an absolute value of the motor current is not compared to a prescribed set value, but the motor current is briefly interrupted completely, and the corresponding interruption of the current can be used to control the cleaner.

It can, for example, be provided that the dosing of a cleaning chemical and/or the activation of a heat exchanger, which is heated by a burner and is placed in the pressure line, are controlled by a brief interruption of the motor current. It can also be provided that the rotational speed of the electric motor and hence the operating pressure of the cleaner are controlled by switching off and subsequently switching on the electric motor again. This provides the user with the possibility of changing the operating pressure of the cleaner in a simple manner by briefly closing the spray nozzle and then opening it again, so that as a result of the strong increase in pressure arising in the pressure line and the strong drop in pressure arising shortly after that, the electric motor can be briefly switched off and subsequently switched on again and, consequently, the motor current briefly interrupted, for example, by means of a signal transducer in the form of a pressure switch. The resulting interruption of the current can then serve as signal to change the operating pressure, starting from a first value, for example, a maximum value arising during normal operation, to a second value. It is subsequently possible to switch over to the first value of the operating pressure again or, for example, to also switch over to a third value of the operating pressure by interrupting the current once again, which is brought about by briefly closing the spray nozzle.

It is particularly advantageous for the operating mode, in particular, the operating pressure, of the cleaner to be changed in a prescribed sequence by repeatedly closing the spray nozzle for a respective time interval that is shorter than the first prescribed period of time. For example, a sequence of several operating pressures can be prescribed. By briefly closing the spray nozzle and hence briefly switching off the electric motor, the user can change the operating pressure in accordance with the prescribed sequence.

Preferably, the cleaner is selectively operated at a maximum operating pressure or at least at an operating pressure that is reduced by 10% to 60% in relation to the maximum operating, pressure. For example, it can be provided that the cleaner is operated at maximum operating pressure, at 80% of the maximum operating pressure or at 60% of the maximum operating pressure, the user being able to change the operating pressure with a prescribed sequence by briefly closing the spray nozzle and hence briefly switching off the electric motor. Preferably, the user can prescribe the value of at least one reduced operating pressure on the cleaner.

In a preferred embodiment of the method, if the spray nozzle is closed by the user for a time interval that is longer than the first prescribed period of time, it is provided that the cleaner is automatically operated again in that operating mode, in particular, at that operating pressure, which prevailed when closing the spray nozzle. Accordingly, if the spray nozzle and preferably also the electric motor are only briefly closed and switched off, respectively, namely for a time interval that is shorter than the first prescribed period of time, then the operating mode of the cleaner changes. If, however, the spray nozzle and preferably also the electric motor are closed and switched off, respectively, for a longer time interval, then that operating mode which prevailed when the closing and the switching-off, respectively, were effected, is set again after opening the spray nozzle and switching on the electric motor again. For example, the user can close the spray nozzle during a cleaning operation for more than two seconds, and after opening the spray nozzle again, that operating pressure is set which prevailed when closing the spray nozzle.

It is particularly advantageous for the cleaner, after an interruption of its supply voltage, to be automatically operated in a prescribed operating mode, in particular, at a prescribed operating pressure. The high-pressure cleaner can comprise an electric connection cable, with which the electric motor can be connected to a supply voltage connection. If the cleaner is put out of operation, the connection cable is usually separated from the supply voltage connection. When the cleaner is later put into operation again, the connection cable is connected to the supply voltage connection again, and the interim interruption of the supply voltage of the electric motor has the consequence that the cleaner automatically transfers to a prescribed operating mode. In particular, it can be provided that after an interruption of the supply voltage, the cleaner is operated at a prescribed operating pressure, for example, at maximum operating pressure.

It is particularly expedient for the cleaner, after the spray nozzle and preferably also the electric motor have been closed and switched off, respectively, longer than a second prescribed period of time, to be automatically operated in a prescribed operating mode, in particular, at a prescribed operating pressure. In particular, such an embodiment is advantageous when, after completion of a cleaning operation, the cleaner is switched off, but without the connection of the electric motor to a supply voltage connection being interrupted. If a new cleaning operation is to be started at a later point in time, in order to do so, the cleaner is then put into operation again. If the interruption lasted longer than a second prescribed period of time, then a prescribed operating mode, in particular, a prescribed operating pressure is automatically set in the cleaner. The closing of the spray nozzle and preferably the switching-off of the electric motor for a time interval that is longer than the second prescribed period of time thus results in an automatic resetting of the cleaner to a prescribed operating mode.

In particular, it can be provided that after the spray nozzle, in particular, also the electric motor, has been closed and switched off, respectively, longer than the second prescribed period of time, the cleaner is operated at maximum operating pressure. Thus, at the start of a cleaning operation, the maximum operating pressure is automatically set in the cleaner, and it can then be changed by the user by briefly closing the spray nozzle and opening the spray nozzle again.

In a cleaner of the generic kind, the object mentioned at the outset is accomplished, in accordance with the invention, in that a first control is providable by the signal transducer by closing the spray nozzle, and a second control signal is providable by the signal transducer by subsequently opening the spray nozzle again, and in that the operating mode of the cleaner is controllable as a function of the duration of the time interval between the first control signal and the second control signal. Closure of the spray nozzle by the user, while the cleaner is operating, results in a pressure increase in the pressure line. The pressure increase can be detected by the signal transducer, which thereupon emits a first control signal. If the spray nozzle is then opened again by the user, the pressure drops in the pressure line. The drop in pressure is also detected by the signal transducer, which thereupon emits a second control signal. The duration of the time interval between the first control signal and the second control signal is used to control the operating mode of the cleaner.

It is particularly advantageous for the pump of the cleaner to be drivable by an electric motor which is adapted to be switched off by the first control signal of the signal transducer and to be switched on by the second control signal of the signal transducer. Consequently, the operating mode of the cleaner is controllable by switching off the electric motor and then switching on the electric motor again. As explained above, the electric motor can be switched off and switched on by means of the control signals of the signal transducer, so that the motor current of the electric motor is interrupted. The duration of the current interruption can be used to control the operating mode of the cleaner. For example, it can be provided that the interruption of the motor current is detectable by a current sensor, and that the current sensor provides a sensor signal which can be evaluated for controlling the operating mode of the cleaner.

Preferably, the operating mode, in particular, the operating pressure, of the cleaner is changeable by closing the spray nozzle and, in particular, by switching off the electric motor for a time interval that is shorter than a first prescribed period of time.

It is expedient for the operating mode, in particular, the operating pressure, of the cleaner to be changeable in a prescribed sequence by repeatedly closing the spray nozzle and, in particular, by repeatedly switching off the electric motor for a respective time interval that is shorter than the first prescribed period of time. For example, it can be provided that the cleaner automatically transfers from a first operating pressure to a second operating pressure by a first brief switching-off of the electric motor. If the electric motor is then briefly switched off once more, the cleaner automatically transfers from the second operating pressure to a third operating pressure. A brief switching-off of the electric motor again can have the consequence that the cleaner transfers from the third operating pressure to the first operating pressure again.

Preferably, the cleaner is selectively operable at maximum operating pressure or at an operating pressure of the cleaning fluid that is reduced by 10% to 60% in relation to the maximum operating pressure. It can, for example, be provided that the cleaner is selectively operable at maximum operating pressure, at 80% of the maximum operating pressure and at 60% of the maximum operating pressure.

It is advantageous for the value of at least one reduced operating pressure to be prescribable by the user. For example, it can be provided that the cleaner comprises a preselection switch for prescribing values for reduced operating pressures.

If the spray nozzle was closed for a time interval, and, preferably, the electric motor was switched off for a time interval that is longer than the first prescribed period of time, then it is advantageous for the cleaner to automatically assume the operating mode prevailing when the closing and the switching-off, respectively, were effected, in particular, the operating pressure prevailing when the closing and the switching-off, respectively, were effected. A closing of the spray nozzle and hence a switching-off of the electric motor for a time interval that is longer than the first prescribed period of time does, therefore, not have the consequence of changing the operating mode, in particular, the operating pressure, of the cleaner.

In a preferred embodiment it is provided that if the supply voltage of the cleaner is interrupted, the cleaner automatically assumes a prescribed operating mode, in particular, a prescribed operating pressure, after the supply voltage has been provided anew. As explained above, the supply voltage can be interrupted by, for example, a connection cable of the cleaner being separated from a supply voltage connection. If the cleaner is put into operation again later, the connection cable is then connected to the supply voltage connection again, and this has the consequence that the cleaner automatically assumes a prescribed operating mode, in particular, a prescribed operating pressure, for example, its maximum operating pressure.

If the spray nozzle has been closed for a time interval and, preferably, the electric motor has been switched off for a time interval that is longer than a second prescribed period of time, then it is expedient for the cleaner to automatically assume a prescribed operating mode, in particular, a prescribed operating pressure. The cleaner has a main switch, with which the electric motor can be switched off, for example, after completion of a cleaning operation. If the cleaner is put into operation again at a later point in time, then the electric motor is switched on again by the main switch. If the cleaner has been out of operation longer than the second prescribed period of time, the cleaner then automatically assumes a prescribed operating mode, in particular, a prescribed operating pressure. The switching-off of the electric motor for a time interval that is longer than the second prescribed period of time, therefore, results in an automatic resetting of the operating mode of the cleaner, so that a cleaning operation can be started by the user with a prescribed operating mode, in particular, at a prescribed operating pressure. If the user wishes to change the operating mode, he can close the spray nozzle briefly and hence, preferably, also switch off the electric motor briefly, in order to do so.

In a particularly preferred embodiment of the cleaner according to the invention, there is placed in the pressure line a signal transducer, for example, a pressure switch which, upon closing the spray nozzle, emits a first control signal and, upon opening the spray nozzle again, emits a second control signal, and which is in operative connection with an electronic control device, which gives a setting signal to a setting element as a function of the duration of the time interval between a first control signal of the signal transducer and a second control signal of the signal transducer, the operating mode of the cleaner being controllable by the setting element. A first control signal and a second control signal are emitted by the signal transducer as a function of the pressure in the pressure line. The first control signal is emitted upon an increase in the pressure in the pressure line caused by closing the spray nozzle, and the second control signal is emitted upon a decrease in the pressure in the pressure line caused by opening the spray nozzle again. The signal transducer is in operative connection with an electronic control device, which provides a setting signal as a function of the duration of the time interval between the two control signals. The signal transducer can be directly connected to the electronic control device, but it can also be provided that the signal transducer cooperates with further components of the cleaner, which, themselves are connected to the electronic control device. For example, it can be provided that the signal transducer cooperates with an interrupter switch, with which the motor current of the electric motor can be interrupted. The interruption of the motor current can be detected by a sensor, which, in turn, is connected to the electronic control device.

Accordingly, it is advantageous for the signal transducer to be connected to an interrupter switch for interruption of the motor current of the electric motor, and for the cleaner to comprise a sensor for detection of an interruption of the motor current, the sensor being coupled with the electronic control device, which gives a setting signal to the setting element as a function of the duration of a current interruption detected by the sensor.

The setting element is preferably configured as phase angle control device, which is placed in a power supply line of the electric motor. By means of the electronic control device, the phase angle control device can provide a setting signal for full-phase or partial-phase opening as a function of the duration of an interruption of the motor current. In the case of full-phase opening, the electric motor operates at a high rotational speed, and the pump driven by it conveys the cleaning fluid at maximum operating pressure. In the case of partial-phase opening, the electric motor operates at a reduced rotational speed, and the pump conveys the cleaning fluid at a reduced operating pressure.

Preferably, after an interruption of the motor current whose duration falls short of a first prescribed period of time, a setting signal is emittable by the electronic control device, which corresponds to a changed operating mode, in particular, a changed operating pressure, compared to the operating mode prevailing prior to the interruption of the motor current. Accordingly, a brief interruption of the motor current has the consequence that the electronic control device emits a setting signal for a changed operating mode.

In a preferred embodiment, the first prescribed period of time lasts 0.5 to 2 seconds, in particular, 1 to 1.5 seconds.

It is expedient if, after repeated interruptions of the motor current whose duration respectively falls short of the first prescribed period of time, a setting signal respectively corresponding to a certain operating mode, in particular, a certain operating pressure, is emittable by the electronic control device, the sequence of the operating modes, in particular, of the operating pressures, being prescribed. If the sensor detects a brief interruption of the motor current, then the electronic control device generates a setting signal, which brings about a prescribed change of the operating mode if the duration of the motor current interruption falls short of the first prescribed period of time. For example, it can be provided that the currently prevailing operating pressure is stored in a storage element. If the sensor detects a brief interruption of the motor current, then this operating pressure is changed in a prescribed sequence, for example, in such a way that starting from a maximum operating pressure, a first reduced operating pressure and a second reduced operating pressure are successively set. In the event of a further brief interruption of the current, the electronic control device then generates a setting signal which again corresponds to the maximum operating pressure.

If the duration of a motor current interruption exceeds the first prescribed period of time, then it is expedient for a setting signal corresponding to the operating mode prevailing prior to the motor current interruption, in particular, to the operating pressure prevailing prior to the motor current interruption, to be emittable by the electronic control device.

As explained above, it is expedient for the electronic control device to comprise a storage element for storing the currently prevailing operating mode, in particular, the currently prevailing operating pressure.

In a particularly preferred embodiment of the cleaner according to the invention, it is provided that if the duration of a motor current interruption exceeds a second prescribed period of time, a setting signal corresponding to a prescribed operating mode, in particular, a prescribed operating pressure, is emittable by the electronic control device.

It is advantageous for an interruption of the supply voltage of the cleaner to be detectable by the electronic control device, and, after such an interruption, for a setting signal corresponding to a prescribed operating mode, in particular, a prescribed operating pressure, to be emittable by the electronic control device. It is expedient for the prescribed operating pressure to be the maximum operating pressure. If the supply voltage of the cleaner is interrupted, for example, by an electric connection cable being separated from a supply voltage connection, then this is detected by the electronic control device. If the cleaner is subsequently put into operation again, the electronic control device then automatically generates a setting signal, which corresponds to a prescribed operating mode, in particular, a prescribed operating pressure. The interruption of the supply voltage, therefore, brings about an automatic resetting of the electronic control device in such a way that it subsequently emits a setting signal which corresponds to a prescribed operating mode.

The following description of a preferred embodiment of the invention serves for more detailed explanation in conjunction with the drawings.

### BRIEF DESCRIPTION OF THE DRAWINGS

FIG. 1 shows a schematic representation of a cleaner according to the invention having a spray nozzle connected to its pressure line, and

FIG. 2 shows a schematic representation of the time-dependent course of the operating pressure of the cleaner at different times at which the spray nozzle is closed.

### DETAILED DESCRIPTION OF THE INVENTION

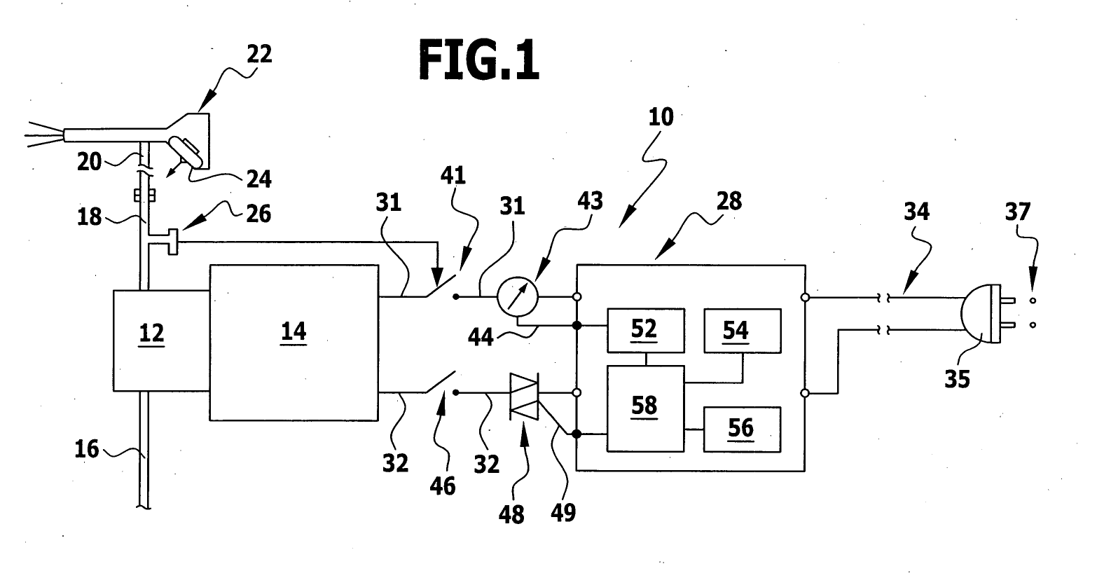

Schematically represented in FIG. 1 is a cleaner according to the invention in the form of a high-pressure cleaner 10, which comprises a high-pressure pump 12 driven by an electric motor 14. Cleaning fluid, preferably water, can be supplied to the high-pressure pump 12 via a suction line 16. The cleaning fluid is pressurized by the high-pressure pump 12 and discharged via a pressure line 18. A spray nozzle in the form of a spray gun 22, known per se, and, therefore, represented only schematically in the drawing, is connected to the pressure line 18 via a high-pressure hose 20. The spray gun 22 comprises in the usual manner an outlet valve, not represented in the drawing, which can be selectively opened and closed by the user with a pivotable actuating lever 24.

A signal transducer in the form of a pressure switch 26 of the high-pressure cleaner 10, which provides a control signal as a function of the pressure prevailing in the pressure line 18, is connected to the pressure line 18. Associated with the electric motor 14 is an electronic control device 28, which is connected to the electric motor 14 via a first power supply line 31 and a second power supply line 32, and to which an electrical connection cable 34 is connected, which carries a connecting plug 35 at its free end. The connection cable 34 can be connected in the usual manner to a supply voltage connection 37, known per se, and, therefore, represented only schematically in the drawing, by means of the connecting plug 35.

There is placed in the first power supply line 31 an interrupter switch 41, which is coupled with the pressure switch 26, so that the interrupter switch 41 can be opened and closed as a function of the control signals of the pressure switch 26 and, consequently, as a function of the cleaning fluid pressure prevailing in the pressure line 18.

There is also placed in the first power supply line 31 a current sensor 43, which gives a sensor signal to the electronic control device 28 via a sensor line 44 if it detects an interruption in the motor current flowing via the first power supply line 31.

There is placed in the second power supply line 32 a main switch 46, which can be manually actuated by the user of the high-pressure cleaner 10. Also placed in the second power supply line 32 is a setting element in the form of a phase angle control device 48, to which a setting signal can be given by the electronic control device 28 via a line 49.

The electronic control device 28 comprises an evaluating unit 52, which is connected to the current sensor 43 via the sensor line 44. The electronic control device 28 also comprises a voltage testing unit 54 as well as a storage unit 56 and a control unit 58. The latter is in electrical communication with the evaluating unit 52, the voltage testing unit 54 and the storage unit 56, and is connected to the phase angle control device 48 via the line 49.

The voltage testing unit 54 tests for the presence of an electric supply voltage at the mains connections of the electronic control device 28. The connection cable 34 is connected to the mains connections. If the connecting plug 35 is connected to the supply voltage connection 37, the electric supply voltage is then present at the mains connections. This is detected by the voltage testing unit 54, which thereupon gives a corresponding signal to the control unit 58.

The high-pressure cleaner 10 has different operating modes, which each differ by a different operating pressure of the cleaning fluid supplied by the high-pressure pump 12 via the pressure line 18 to the spray gun 22. To attain the different operating pressures, the electric motor 14 can operate at different rotational speeds. The rotational speeds are set by means of the phase angle control device, which, to do so, receives a corresponding setting signal from the electronic control device 28 via the line 49.

When the connection cable 34 is connected to the supply voltage connection 37, and the main switch 46 is switched on, the interrupter switch 41 coupled with the pressure switch 26 first closes, and the electric motor 14 is started, so that the high-pressure pump 12 conveys cleaning fluid at maximum operating pressure, which can be discharged via the spray gun 22. If the spray gun 22 is closed by the user, the pressure in the pressure line 18 then rises briefly above the maximum pressure that is set during normal operation of the pump. This has the consequence that the pressure switch 26 gives the interrupter switch 41 a first control signal to open, so that the connection of the electric motor 14 to the electronic control device 28 via the first power supply line 31 is interrupted. The resulting interruption of the motor current is detected by the current sensor 43, which thereupon gives a corresponding sensor signal to the evaluating unit 52 via the sensor line 44. If the spray gun 22 is then opened again by the user, the pressure in the pressure line falls briefly below a prescribed minimum value. This has the consequence that a second control signal is issued by the pressure switch 26, whereupon the interrupter switch 41 transfers again to its closed position, and, consequently, the interruption of the motor current is terminated. The duration of the motor current interruption detected by the current sensor 43 and, consequently, the duration of the time interval between the first and second control signals is detected by the evaluating unit 52 and compared with a prescribed first period of time of one second. If the duration of the motor current interruption falls short of the prescribed period of time, the evaluating unit 52 then gives a signal to the control unit 58, which thereupon changes the setting signal given to the phase angle control device 48. Instead of a setting signal for full-phase opening, a setting signal for partial-phase opening is then sent to the phase angle control device. This has the consequence that the electric motor 14 operates at reduced rotational speed and, therefore, the high-pressure pump 12 provides a reduced operating pressure.

The respective operating pressure is stored in the storage unit 56, so that when a subsequent motor current interruption occurs again, whose duration falls short of the first prescribed period of time, a setting signal that has been changed once more can be transmitted to the phase angle control device 48 by the control unit 58, so that an operating pressure that has been reduced once more is set.

If, however, the duration of the motor current interruption exceeds the first prescribed period of time, then the high-pressure cleaner 10 is operated at the same operating pressure as prevailed before the start of the motor current interruption by the corresponding operating pressure being recalled from the storage unit 56.

If the connecting plug 35 is separated from the supply voltage connection 37, the voltage testing unit 54 detects a supply voltage failure. This has the consequence that when the high-pressure cleaner 10 is subsequently started again, the control unit 58 gives a setting signal for full-phase opening to the phase angle control device 48, so that the maximum operating pressure is set. This also applies accordingly when the user opens the main switch 46 for a time interval that exceeds a prescribed second period of time of, for example, 20 minutes. When, after such a long interruption of the motor current, the cleaner is switched on again, the control unit 58 then likewise gives a setting signal for full-phase opening to the phase angle control device 48, so that the high-pressure pump 12 conveys cleaning fluid at maximum operating pressure.

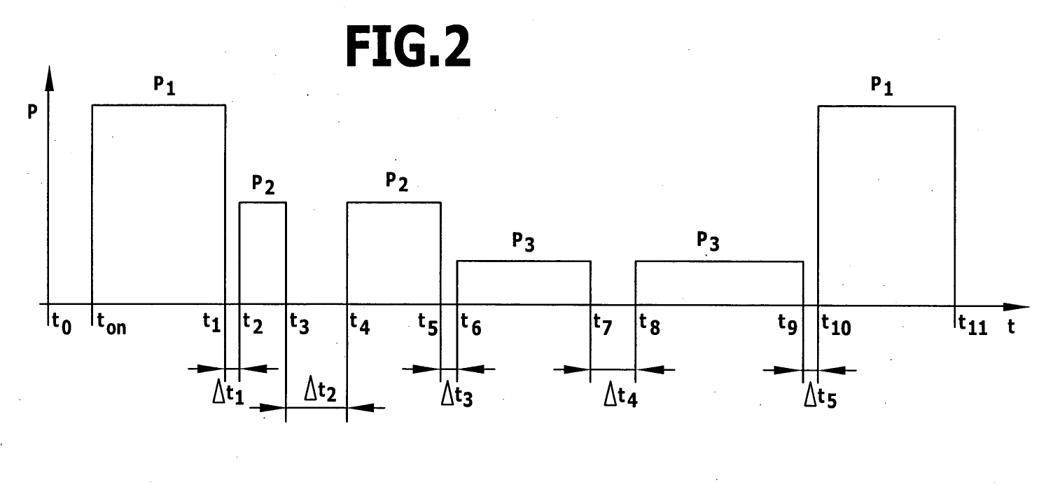

The course of the operating pressures at different closure times of the spray gun 22 is represented in FIG. 2.

At the point in time t₀, the switched-off high-pressure cleaner 10 is connected to the supply voltage connection 37. At the point in time tₒₙ, the main switch 46 is closed, so that operation of the high-pressure cleaner 10 starts. Since the connecting plug 45 was separated from the supply voltage connection 37 before the point in time t₀, the high-pressure pump 12 first operates at maximum operating pressure p₁. If the user briefly closes the spray gun 22 at the point in time t₁ and opens it again at the point in time t₂, the time interval Δt₁ being shorter than the first prescribed period of time of one second, the operating pressure p₂, which, for example, may have a value of 80% of the maximum operating pressure p₁, is then automatically set.

If the spray gun is closed again at the point in time t₃ and only opened again at the point in time t₄, the time interval Δt₂ being greater than the first prescribed period of time but shorter than a second prescribed period of time of, for example, 20 minutes, the high-pressure pump 12 then operates again unchanged at the operating pressure p₂ that prevailed at the point in time t₃. If the spray gun is closed at the point in time t₅ and opened again at the point in time t₆, the time interval Δt₃ being shorter than the first prescribed period of time, the power of the high-pressure cleaner 10 is then changed again by the reduced operating pressure p₃ with a value of, for example, 60% of the maximum operating pressure being set.

If the spray gun 22 is closed again at the point in time t₇ and only opened again at the point in time t₈, the time interval Δt₄ being greater than the first prescribed period of time but shorter than the second prescribed period of time, operation of the high-pressure cleaner 10 then continues at the reduced operating pressure p₃ that prevailed at the point in time t₇. If the spray gun is briefly closed at the point in time t₉ and opened again at the point in time t₁₀, the time interval Δt₅ being shorter than the first prescribed period of time, the high-pressure cleaner then automatically transfers to an operating mode in which the maximum operating pressure p₁ is again set, until the spray gun 22 is closed for quite a long time at the point in time t₁₁.

From the foregoing it will be clear that by briefly closing the spray nozzle and, in particular, by briefly interrupting the motor current, the operating pressure of the high-pressure cleaner 10 can be changed in a simple way in a prescribed sequence, in which, starting from the maximum operating pressure p₁, which, for example, may be 100 bar, after a first brief interruption of the motor current, a reduced operating pressure p₂ of, for example, 80 bar is set, and upon a further brief interruption of the motor current, a reduced operating pressure with a value of, for example, 60 bar is set. Subsequently, upon a further brief interruption of the motor current, the high-pressure cleaner 10 automatically transfers again to the operating mode at maximum operating pressure p₁. Transfer to a changed operating pressure does, however, only occur when the duration of the motor current interruption falls short of the first prescribed period of time of, for example, one second. If the duration of the motor interruption exceeds this period of time, then the operating pressure is not changed, rather, the operating pressure prevailing at the start of the motor current interruption is set again in the event the interruption of the motor current did not last longer than a second prescribed period of time. If, however, the duration of the motor current interruption exceeds the second prescribed period of time of, for example, 20 minutes, or if the connecting plug 35 is separated from the supply voltage connection 37, then the maximum operating pressure p₁ is automatically set again when the high-pressure cleaner is started up again.

1. Method for controlling the operating mode of a cleaner, in particular, a high-pressure cleaner, wherein a pump delivers cleaning fluid via a pressure line to a closable spray nozzle, a signal transducer which provides control signals as a function of the pressure in the pressure line being coupled with the pressure line, wherein a first control signal is provided by the signal transducer by closing the spray nozzle, and a second control signal is provided by the signal transducer by subsequently opening the spray nozzle again, wherein the operating mode of the cleaner is controlled as a function of the duration of the time interval between the two control signals, and wherein the operating mode, in particular, the operating pressure, of the cleaner is changed if the time interval between the first control signal and the second control signal is shorter than a first prescribed period of time.

2. Method in accordance with claim 1, wherein the pump is driven by an electric motor, which is switched off by the first control signal of the signal transducer and is switched on by the second control signal of the signal transducer.

3. Method in accordance with claim 1, wherein the operating mode, in particular, the operating pressure, of the cleaner is changed in a prescribed sequence by repeatedly closing the spray nozzle for a respective time interval that is shorter than the first prescribed period of time.

4. Method in accordance with claim 1, wherein the cleaner is selectively operated at maximum operating pressure or at an operating pressure of the cleaning fluid that is reduced by 10% to 60% in relation to the maximum operating pressure.

5. Method in accordance with claim 1, wherein after the spray nozzle has been closed for a time interval that is longer than the first prescribed period of time, the cleaner is automatically operated again in that operating mode, in particular, at that operating pressure, which prevailed when closing the spray nozzle, upon opening the spray nozzle again.

6. Method in accordance with claim 1, wherein the cleaner, after an interruption of its supply voltage, is automatically operated in a prescribed operating mode, in particular, at a prescribed operating pressure.

7. Method in accordance with claim 6, wherein the cleaner, after an interruption of its supply voltage, is operated at maximum operating pressure.

8. Method in accordance with claim 1, wherein after the spray nozzle has been closed for a time interval that is longer than a second prescribed period of time, the cleaner is automatically operated in a prescribed operating mode, in particular, at a prescribed operating pressure.

9. Method in accordance with claim 8, wherein after the spray nozzle has been closed for a time interval that is longer than the second prescribed period of time, the cleaner is operated at maximum operating pressure.

10. Cleaner, in particular, high-pressure cleaner, for performing the method in accordance with claim 1, having a pump for delivering cleaning fluid via a pressure line to a closable spray nozzle, wherein a signal transducer is coupled with the pressure line for providing control signals as a function of the pressure in the pressure line, wherein a first control signal is emittable by the signal transducer by closing the spray nozzle, and a second control signal is emittable by the signal transducer by subsequently opening the spray nozzle again, wherein the operating mode of the cleaner is controllable as a function of the duration of the time interval between the first control signal and the second control signal, and wherein the operating mode, in particular, the operating pressure, of the cleaner is changeable by closing the spray nozzle for a time interval that is shorter than a first prescribed period of time.

11. Cleaner in accordance with claim 10, wherein the pump is drivable by an electric motor, which is adapted to be switched off by the first control signal of the signal transducer and to be switched on by the second control signal of the signal transducer.

12. Cleaner in accordance with claim 10, wherein the operating mode, in particular, the operating pressure, of the cleaner is changeable in a prescribed sequence by repeatedly closing the spray nozzle for a respective time interval that is shorter than the first prescribed period of time.

13. Cleaner in accordance with claim 10, wherein the cleaner is selectively operable at maximum operating pressure or at an operating pressure of the cleaning fluid that is reduced by 10% to 60% in relation to the maximum operating pressure.

14. Cleaner in accordance with claim 13, wherein the value of at least one reduced operating pressure is prescribable by the user.

15. Cleaner in accordance with claim 10, wherein after the spray nozzle has been closed for a time interval that is longer than the first prescribed period of time, the cleaner automatically assumes its operating mode that prevailed when closing the spray nozzle, in particular, the operating pressure that prevailed when closing the spray nozzle, upon opening the spray nozzle again.

16. Cleaner in accordance with claim 10, wherein after an interruption of its supply voltage, the cleaner automatically assumes a prescribed operating mode, in particular, a prescribed operating pressure.

17. Cleaner in accordance with claim 16, wherein after an interruption of its supply voltage, the cleaner automatically assumes its maximum operating pressure.

18. Cleaner in accordance with claim 10, wherein the cleaner automatically assumes a prescribed operating mode, in particular, a prescribed operating pressure, after the spray nozzle has been closed for a time interval that is longer than a second prescribed period of time.

19. Cleaner in accordance with claim 10, wherein there is placed in the pressure line a signal transducer which, upon closing the spray nozzle, emits a first control signal, and, upon opening the spray nozzle again, emits a second control signal, and which is in operative connection with an electronic control device, which gives a setting signal to a setting element as a function of the duration of the time interval between a first control signal and a second control signal of the signal transducer, the operating mode of the cleaner being controllable by the setting element.

20. Cleaner in accordance with claim 19, wherein the signal transducer is connected to an interrupter switch for interruption of the motor current of the electric motor, and in that the cleaner comprises a sensor for detection of an interruption of the motor current, the sensor being coupled with the electronic control device, which gives a setting signal to the setting element as a function of the duration of a current interruption detected by the sensor.

21. Cleaner in accordance with claim 19, wherein the setting element is configured as phase angle control device, which is placed in a power supply line of the electric motor.

22. Cleaner in accordance with claim 20, wherein after an interruption of the motor current whose duration falls short of a first prescribed period of time, a setting signal is emittable by the electronic control device, which corresponds to a changed operating mode, in particular, a changed operating pressure, compared to the operating mode prevailing prior to the interruption of the current.

23. Cleaner in accordance with claim 22, wherein the first prescribed period of time is 0.5 seconds to 2 seconds.

24. Cleaner in accordance with claim 22, wherein in the event of repeated interruptions of the motor current whose duration respectively falls short of the first prescribed period of time, a setting signal corresponding to a certain operating mode, in particular, a certain operating pressure, is respectively emittable by the electronic control device, the sequence of the operating modes, in particular, of the operating pressures, being prescribed.

25. Cleaner in accordance with claim 20, wherein after a motor current interruption whose duration exceeds the first prescribed period of time, a setting signal corresponding to the operating mode prevailing prior to the motor current interruption, in particular, to the operating pressure prevailing prior to the motor current interruption, is emittable by the electronic control device.

26. Cleaner in accordance with claim 19, wherein the electronic control device comprises a storage unit for storing the currently prevailing operating mode, in particular, the currently prevailing operating pressure.

27. Cleaner in accordance with claim 20, wherein after a motor current interruption whose duration exceeds a second prescribed period of time, a setting signal corresponding to a prescribed operating mode, in particular, a prescribed operating pressure, is emittable by the electronic control device.

28. Cleaner in accordance with claim 19, wherein an interruption of the supply voltage of the cleaner is detectable by the electronic control device and, after an interruption of the supply voltage, a setting signal corresponding to a prescribed operating mode, in particular, a prescribed operating pressure, is emittable by the electronic control device.

29. Cleaner in accordance with claim 27, wherein the prescribed operating pressure is the maximum operating pressure of the cleaner.
